(19) United States
(12) Patent Application Publication
(10) Pub. No.: US 2002/0134607 A1
(43) Pub. Date: Sep. 26, 2002

(54) Method of impact detection for a motor vehicle

(76) Inventor: Rolf-Jurgen Recknagel, Jena (DE)

Correspondence Address: KENYON & KENYON, ONE BROADWAY, NEW YORK, NY, 10004, US

(21) Appl. No.: 10/045,767

(22) Filed: Jan. 10, 2002

(30) Foreign Application Priority Data
Jan. 11, 2001 (DE) 1 01 00 880.5-21

(51) Int. Cl. B60K 28/14

(52) U.S. Cl. 180/274

(57) ABSTRACT

A method for detecting impact for a motor vehicle, a crash crumple zone extension and restraining device being employed as a function of an effective mass of an impact object, determined on the basis of precrash sensor signals. In this context, a head-on collision and/or a side collision can be detected. The effective mass is compared to predefined threshold values to classify the impact object. The classification then determines the use of the restraining device.

### BACKGROUND INFORMATION

Today, impact is detected using acceleration sensors that are either centrally or externally attached to the motor vehicle. Given decentralized sensing using one to two peripheral acceleration sensors per vehicle side, the acceleration sensors are closer to the impact location of the object. This prevents signal delays and attenuation. However, in this context, certain driving maneuvers where it is not desired to trigger the restraining means generate signals that are very similar to those of a real collision. In the case of a head-on collision, protection is only possible up to about 65 km/h, since, on the one hand, the deformation zone or the crash crumple zone is too small and, on the other hand, a certain amount of time is required to deploy the restraining means. In the case of a side collision, the situation is even more critical.

### SUMMARY OF THE INVENTION

In comparison with the related art, the method of impact detection for a motor vehicle according to the present invention has the advantage that the vehicle occupants are better protected at higher speeds. In particular, this is achieved in that the entire crash crumple zone is lengthened by the extendable crash crumple zone. By determining the effective mass of the impact object, it is possible to detect lighter objects in order to trigger the appropriate restraining means on the outside of the vehicle in the case of a pedestrian, for example. In this context, the method of the present invention also decreases the damage to the vehicle in the event of a collision and, thus, reduces the potential cost of repairs. The extendable crash crumple zone has simple properties since an approximately constant force for this extendable crash crumple zone is assumed.

It is particularly advantageous that either a head-on collision or a side collision is detected. In particular, a side impact at the particularly small deformation zone is especially critical in this respect and, therefore, profits even more than a head-on collision from the method of the present invention.

Moreover, the restraining force of the crash crumple zone extension is selected such that it corresponds to the restraining force of the crash crumple zone.

Furthermore, it is advantageous that the relative acceleration between the motor vehicle and the impact object is determined from the precrash signals, the effective mass being determined from the relative acceleration and the restraining force.

It is also advantageous that the effective mass is compared to predefined threshold values to classify the impact object in order to adaptively extend or to trigger the restraining means and the crash crumple zone extension on the basis of the classification. Thus, it is achieved, for example, that a pedestrian is also taken into consideration by the extendable crash crumple zone, in that the restraining means, such as an external airbag, are used for the pedestrian's protection so that injuries are as minimal as possible. The restraining means inside of the motor vehicle are, thereby, also optimally employed, since the impact object can be used to determine the crash severity. Increased protection for the vehicle occupants is, thus, ensured.

Furthermore, it is advantageous that the device of the invention for implementing the method of the present invention has at least two precrash sensors to determine the impact direction, a control unit for the restraining means for processing the precrash sensor signals and for controlling the restraining means or the crash crumple zone extension, the extendable crash crumple zone extension, which preferably has at least parts of the bumper of the motor vehicle, and the restraining means. In this context, the precrash sensors can be configured as radar sensors. However, optical or ultrasonic sensors can also be used.

### BRIEF DESCRIPTION OF THE DRAWING

FIG. 1 shows a block diagram of the device according to the present invention.

FIG. 2 shows an impact situation.

FIG. 3 shows a flow chart of the method according to the present invention.

### DETAILED DESCRIPTION

In the event that a motor vehicle collides with an impact object, the length of the deformation zone of the vehicle is decisive for the severity of the crash. The effective mass of the impact object and the impact speed or the impact force are also determining parameters for the crash severity. Thus, according to the present invention, a method of impact detection for a motor vehicle is provided that extends a crash crumple zone extension and adaptively triggers restraining means as a function of the effective mass of the impact object. This is possible for a head-on collision as well as for a side collision.

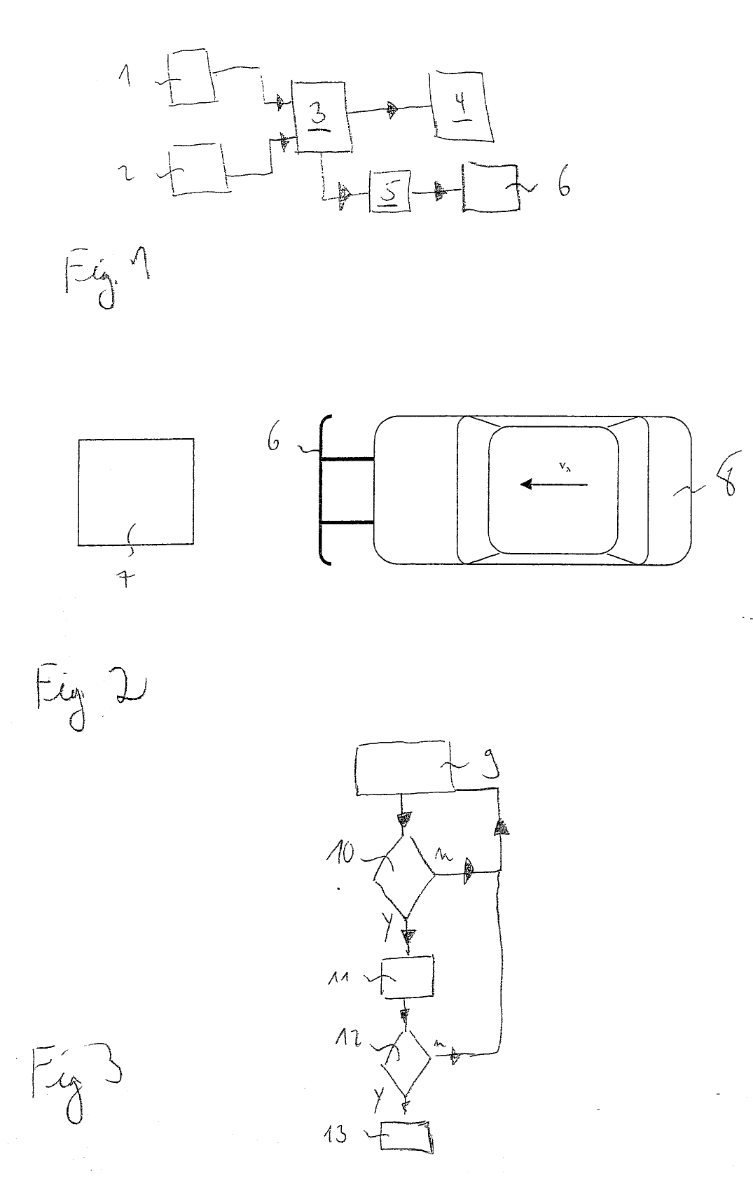

FIG. 1 shows a block diagram of the device according to the present invention. Two precrash sensors 1 and 2 are connected to a first and a second input of a control unit 3. Restraining means 4 are connected to a first data output of control unit 3. A signal processing element 5 is connected to a second data output of control unit 3, a crash crumple zone extension 6 being in turn connected to the signal processing element's data output.

In this instance, restraining means 4 are airbags and belt tighteners that can be used in stages, i.e., the restraining force exerted by the restraining means can be adjusted.

Prior to impact, precrash sensors 1 and 2 detect and follow the approach of an impact object to the vehicle in which the device of the present invention is located. In this context, precrash sensors 1 and 2 are designed as radar sensors having a typical visibility range of 7 m. If the impact object comes closer than 1.5 m, a collision can be assumed with a high degree of certainty. Precrash sensors 1 and 2 provide information regarding the radial speed of approach as well as regarding the direction and relative speed of the object in the direction of the longitudinal axis of the vehicle.

On the basis of this information, crash crumple zone extension 6 is then extended by control unit 3 via signal processing element 5. Crash crumple zone extension 6 then opposes the approaching impact object with a force F, which is as constant as possible. This force F is selected with respect to the deformation properties of crash crumple zone extension 6 or its attachment such that force F approximately corresponds to the force that the actual crash crumple zone generates as a result of its stiffness, and it remains largely constant over the deformation distance. However, in this context, it is to be ensured by constructive measures that the crash crumple zone extension deforms first and then the crash crumple zone itself, it being necessary for the crash crumple zone extension to be able to be extended very quickly. Suitable actuators that are electrically controlled are present for this purpose. In this instance, a spring, for example, can be used for the extending operation.

Known force F corresponds to the force acting between the impact object and the vehicle. As a result, the relative speed between the vehicle and the impact object is reduced. This decrease is measured by precrash sensors 1 and 2, thereby resulting in relative deceleration aᵣₓ. The simple characteristics of synthetic crash crumple zone extension 6 and the approximately constant force can be used to precisely predict the response of the crash crumple zone extension, and the response can, thus, be used to determine the crash severity. Acting on the impact object and the vehicle is force F, which results from mass m and deceleration a of the vehicle as well as from the effective mass and the acceleration of the object as follows:

F=m·a=−m_{eff}·a_{eff} (1)

The term effective was selected because it does not relate to the actual mass or acceleration of the center of mass of the impact object but to the acceleration or deceleration of the surface measured by precrash sensors 1 and 2 and of the mass, which results from the deformation characteristics.

In this context, it is then also clear that after the impact object contacts crash crumple zone extension 6, precrash sensors 1 and 2 can only detect those parts of the impact object that can be covered and, thus, pushed away by crash crumple zone extension 6. Otherwise, it can occur, for example, that a pedestrian whose legs are pushed away by the extension and whose center of mass initially experiences almost no acceleration is detected as an object having a particularly great mass.

The effective acceleration results from the relative deceleration and the deceleration of the vehicle:

a_{eff}=aᵣₓ−a (2)

The effective mass is then obtained using equation 1:

$${m}_{eff} = \frac{m \cdot a}{{a}_{rx} - a} = \frac{F}{m \cdot {a}_{rx} - F} \cdot m \qquad ( 3 )$$

Thus, there are two possibilities for calculating the effective mass, on the one hand, from acceleration a measured by the acceleration sensors in the vehicle and, on the other hand, from force F. Together with the relative speed, the effective mass is a measure of the crash severity. The restraining means can then be adaptively, i.e. in a manner adapted to the crash severity, triggered as a function of these quantities. If a pedestrian is detected by the value of the effective mass in that control unit 3 calculates the effective mass and the acceleration and compares them to threshold values, appropriate restraining means 4 for the pedestrian can be activated, e.g. the engine hood can be adjusted or the external airbag can be actuated.

Precrash sensors 1 and 2, which are configured as radar sensors in this instance, have electronics for signal processing. In this context, the digitalization can either be performed in precrash sensors 1 and 2 themselves or in control unit 3. Restraining means 4 are restraining means in the passenger compartment as well as restraining means attached, if desired, to the vehicle house in order to protect pedestrians. In this instance, crash crumple zone extension 6 is configured as an extendable bumper. However, other constructions are also possible, it being possible for only parts of the bumper to form crash crumple zone extension 6.

FIG. 2 shows a crash situation. An impact object 7, e.g. a wall, is detected by precrash sensors 1 and 2, and control unit 3 detects that a collision is highly probable. Therefore, crash crumple zone extension 6 is extended to lengthen the deformation zone of vehicle 8. At the same time, restraining means 4 for the vehicle occupants are adaptively triggered. In this context, the relative mass of impact object 7 and the relative impact speed in the direction of the crash crumple zone extension are decisive (in the case of impact in a direction perpendicular to a wall, this is vehicle speed vₓ).

In FIG. 3, the method of the present invention for detecting impact for a motor vehicle is represented as a flow chart. In process step 9, precrash sensors 1 and 2, which can also be supplemented by additional precrash sensors, detect an impact object. In this context, the precrash signals are transmitted to control unit 3. In process step 10, control unit 3 checks whether impact is highly probable. If the impact object is detected at a distance of a maximum of 1.5 m and a speed exceeding a predefined threshold value, control unit 3 detects a possible collision and continues with process step 11 to determine the effective mass of impact object 7. The crash crumple zone extension is also extended.

In process step 12, a decision is made on the basis of the effective mass and the relative speed as to whether a critical impact necessitating that the restraining means be triggered is taking place. If no critical impact is detected, the process jumps back to process step 9, and the crash crumple zone extension is retracted. Otherwise, restraining means 4 are triggered in step 13 in accordance with the effective mass and the relative speed or the impact force. In this context, external airbags can also be triggered in order to protect pedestrians.

What is claimed is:

1. A method of impact detection for a motor vehicle in which an impact with an impact object is detected early using precrash sensors, the method comprising:
extending a crash crumple zone extension in an impact direction as a function of precrash sensor signals from the precrash sensors; and
determining an effective mass of the impact object as a function of the precrash sensor signals to adaptively trigger at least one restraining device.

2. The method according to claim 1, further comprising:
detecting at least one of a head-on collision and a side collision.

3. The method according to claim 1, wherein a restraining force of the crash crumple zone extension corresponds to a restraining force of a crash crumple zone.

4. The method according to claim 1, further comprising:
determining a relative acceleration between the motor vehicle and the impact object from the precrash sensor signals, and
wherein the effective mass is determined from the relative acceleration and a restraining force.

5. The method according to claim 1, further comprising:
comparing the effective mass to predefined threshold values to classify the impact object.

6. The method according to claim 5, further comprising:
employing the at least one restraining device as a function of a classification of the impact object.

7. A device comprising:
at least two precrash sensors for a motor vehicle providing precrash sensor signals;
a control unit to process the precrash sensor signals;
an extendable crash crumple zone extension controlled by the control unit; and
at least one restraining device.

8. The device according to claim 7, wherein the precrash sensors are radar sensors.

9. The device according to claim 7, wherein the crash crumple zone extension has at least parts of a bumper of the motor vehicle.
